(19) United States
(12) Patent Application Publication
(10) Pub. No.: US 2020/0139713 A1
(43) Pub. Date: May 7, 2020

(54) LIQUID DISCHARGE APPARATUS AND INK JET PRINTER

(71) Applicant: TOSHIBA TEC KABUSHIKI KAISHA, Tokyo (JP)

(72) Inventor: Ryutaro Kusunoki, Mishima Shizuoka (JP)

(21) Appl. No.: 16/550,460

(22) Filed: Aug. 26, 2019

(30) Foreign Application Priority Data
Nov. 6, 2018 (JP) 2018-208557

(51) Int. Cl. B41J 2/165; B41J 2/14; B41J 2/045

(52) U.S. Cl. CPC B41J 2/16538; B41J 2002/16502; B41J 2/04581; B41J 2/14201

(57) ABSTRACT

According to one embodiment, a liquid discharge apparatus includes a nozzle plate configured such that a plurality of nozzles are arranged, a liquid supply unit, an actuator, a driving circuit, and a low impedance circuit. The nozzles arranged in the nozzle plate discharge a liquid. The liquid supply unit communicates with the nozzles. The actuator is provided for each nozzle in the nozzle plate. The actuator includes a piezoelectric element. The driving circuit supplies a driving signal to the piezoelectric element of the actuator and drives the actuator to discharge a liquid from the nozzles. The low impedance circuit is connected to the piezoelectric element of the actuator while stress is applied to the nozzle plate due to external factors.

### CROSS-REFERENCE TO RELATED APPLICATIONS

This application is based upon and claims the benefit of priority from Japanese Patent Application No. 2018-208557, filed Nov. 6, 2018, the entire contents of which are incorporated herein by reference.

### FIELD

Embodiments described herein relate generally to a liquid discharge apparatus and an ink jet printer.

### BACKGROUND

Liquid discharge apparatuses that supply a predetermined amount of liquid to predetermined positions are known. A liquid discharge apparatus is mounted on, for example, an ink jet printer, a 3D printer, a dispensing apparatus, or the like. The ink jet printer discharges ink droplets from an ink jet head to form an image or the like on the surface of a recording medium. The 3D printer discharges droplets of a molding material from a molding material discharge head and hardens the droplets to forma three-dimensional modeled object. The dispensing apparatus supplies a predetermined amount of droplets of a sample to a plurality of containers or the like.

The liquid discharge apparatus drives an actuator to discharge a liquid from a nozzle formed in a nozzle plate. The actuator including a piezoelectric body is driven by the piezoelectric body being deformed due to a piezoelectric effect when a driving signal is supplied thereto from a driving circuit. When a liquid is discharged from the nozzle, the liquid may be attached to the nozzle plate. The liquid attached to the nozzle plate is removed by a cleaning apparatus.

However, when the nozzle plate is cleaned using a cleaning member such as a wiper blade, the nozzle plate is deformed due to stress such as a pressing force and a frictional force, and the piezoelectric body of the actuator is further generated, which may generate charge due to a piezoelectric effect. When charge is generated in the piezoelectric body of the actuator, there is a concern that adverse influences may be exerted due to a voltage applied to the driving circuit. In some cases, there is a concern that elements and the like of the driving circuit may be broken.

### DESCRIPTION OF THE DRAWINGS

FIG. 1 is an overall configuration diagram showing an ink jet printer according to a first embodiment;

FIG. 2 is a perspective view of an ink jet head of the ink jet printer;

FIG. 3 is a plan view of a nozzle plate of the ink jet head;

FIG. 4 is a longitudinal sectional view of the ink jet head;

FIG. 5 is a longitudinal sectional view of the nozzle plate of the ink jet head;

FIG. 6 is a perspective view of a cleaning apparatus of the ink jet head;

FIG. 7 is a block configuration diagram of a control system of the ink jet printer;

FIG. 8 is a circuit diagram of a driving circuit that drives an actuator of the ink jet head;

FIG. 9 is a waveform diagram of a driving signal to be supplied to the actuator;

FIGS. 10A to 10E are views illustrating operations of the actuator that supplies the driving signal;

FIG. 11 is a flowchart showing a procedure of cleaning of a nozzle surface of the ink jet head;

FIG. 12 is a circuit diagram showing the state of the driving circuit when the cleaning is performed;

FIG. 13 is a view illustrating operations of the cleaning apparatus when the cleaning is performed;

FIG. 14 is a view illustrating operations of the cleaning apparatus when the cleaning is performed;

FIG. 15 is a circuit diagram showing the state of the driving circuit when the cleaning is performed;

FIG. 16 is a circuit diagram of a driving circuit that drives an actuator of an ink jet head according to a second embodiment;

FIG. 17 is a longitudinal sectional view illustrating a cleaning apparatus of an ink jet head according to a third embodiment;

FIG. 18 is a longitudinal sectional view illustrating a cleaning apparatus of an ink jet head according to a fourth embodiment; and

FIG. 19 is a longitudinal sectional view showing a modification example of the ink jet head.

### DETAILED DESCRIPTION

Embodiments provide a liquid discharge apparatus capable of protecting a driving circuit when stress is applied due to external factors, such as at the time of cleaning of a nozzle plate in which a plurality of nozzles for discharging a liquid are arranged, and an ink jet printer.

In general, according to one embodiment, a liquid discharge apparatus includes a nozzle plate configured such that a plurality of nozzles is arranged, a liquid supply unit, an actuator, a driving circuit, and a low impedance circuit. The nozzles arranged in the nozzle plate discharge a liquid. The liquid supply unit communicates with the nozzles. The actuator is provided for each nozzle in the nozzle plate. The actuator includes a piezoelectric element. The driving circuit supplies a driving signal to the piezoelectric element of the actuator and drives the actuator to discharge a liquid from the nozzles. The low impedance circuit is connected to the piezoelectric element of the actuator while stress is applied to the nozzle plate due to external factors.

Hereinafter, liquid discharge apparatuses according to embodiments will be described with reference to the accompanying drawings. Meanwhile, in the drawings, the same components will be denoted by the same reference numerals and signs.

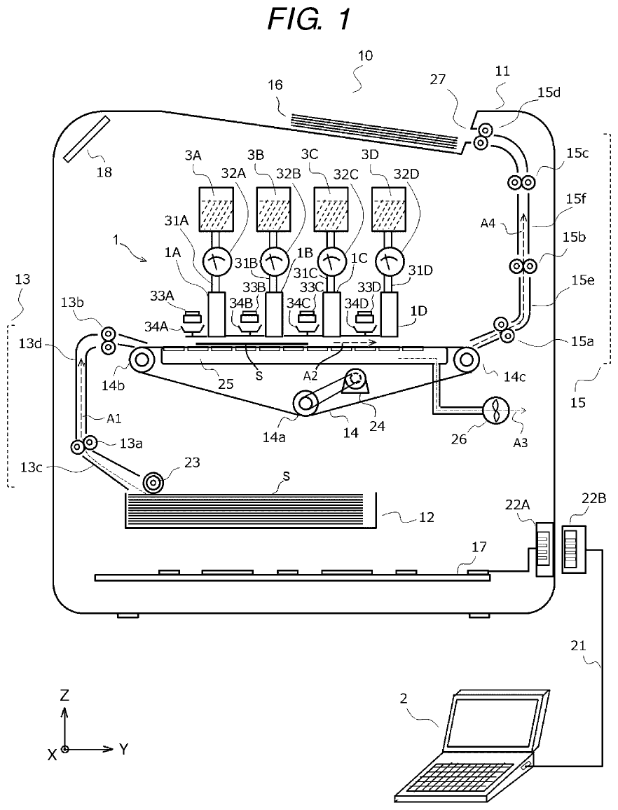

As an example of an image forming apparatus having a liquid discharge apparatus 1 according to an embodiment mounted thereon, an ink jet printer 10 that prints an image on a recording medium will be described. FIG. 1 shows a schematic configuration of the ink jet printer 10. The ink jet printer 10 includes, for example, a box-shaped housing 11 which is an exterior body. A cassette 12 that accommodates sheets S which are examples of a recording medium, an upstream transport path 13 for the sheet S, a transport belt 14 that transports the sheet S taken out from the cassette 12, ink jet heads 1A to 1D that discharge ink droplets toward the sheet S on the transport belt 14, a downstream transport path 15 for the sheet S, an ejection tray 16, and a control substrate as a control unit 17 are disposed inside the housing 11. An operation unit 18 which is a user interface is disposed on a side of an upper portion of the housing 11.

Image data to be printed on the sheet S is generated by, for example, a computer 2 which is external connection equipment. The image data generated by the computer 2 is transmitted to the control unit 17 of the ink jet printer 10 through a cable 21 and connectors 22B and 22A.

A pick-up roller 23 supplies the sheets S from the cassette 12 to the upstream transport path 13 one by one. The upstream transport path 13 is constituted by feed roller pairs 13a and 13b and sheet guide plates 13c and 13d. The sheet S is transmitted to an upper surface of the transport belt 14 through the upstream transport path 13. In the drawing, an arrow A1 indicates a transport path of the sheet S from the cassette 12 to the transport belt 14.

The transport belt 14 is a net-like endless belt having a large number of through holes formed in the surface thereof . Three rollers including a driving roller 14a and driven rollers 14b and 14c rotatably support the transport belt 14. A motor 24 rotates the transport belt 14 by rotating the driving roller 14a. The motor 24 is an example of a driving apparatus. In the drawing, A2 indicates a rotation direction of the transport belt 14. A negative pressure container 25 is disposed on the back side of the transport belt 14. The negative pressure container 25 is continuous with a decompression fan 26 and is configured such that the inside of the container changes to a negative pressure due to an air current formed by the fan 26. The sheet S is adsorbed and held by the upper surface of the transport belt 14 due to the inside of the negative pressure container 25 changing to a negative pressure. In the drawing, A3 indicates a flow of an air current. The transport belt 14 is an example of a recording medium transport apparatus.

The ink jet heads 1A to 1D are disposed so as to face the sheet S adsorbed and held on the transport belt 14 through a narrow gap of, for example, 1 mm. The ink jet heads 1A to 1D individually discharge ink droplets toward the sheet S. An image is formed on the sheet S when the sheet S passes below the ink jet heads 1A to 1D. The ink jet heads 1A to 1D have the same structure except that colors of ink to be discharged are different from each other. The colors of the ink are, for example, cyan, magenta, yellow, and black.

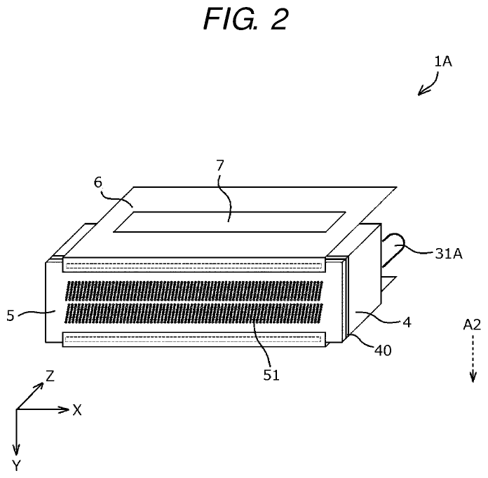

The ink jet heads 1A to 1D are respectively connected to ink tanks 3A to 3D and ink supply pressure adjustment apparatuses 32A to 32D through ink flow channels 31A to 31D. The ink flow channels 31A to 31D are, for example, resin tubes. The ink tanks 3A to 3D are containers in which ink is stored. The ink tanks 3A to 3D are respectively disposed above the ink jet heads 1A to 1D. The ink supply pressure adjustment apparatuses 32A to 32D adjust the insides of the ink jet heads 1A to 1D to a negative pressure, for example, −1 kPa with respect to atmospheric pressure so that ink does not leak from nozzles 51 (see FIG. 2) of the ink jet heads 1A to 1D during waiting. Ink inside the ink tanks 3A to 3D is supplied to the ink jet heads 1A to 1D by the ink supply pressure adjustment apparatuses 32A to 32D during image formation.

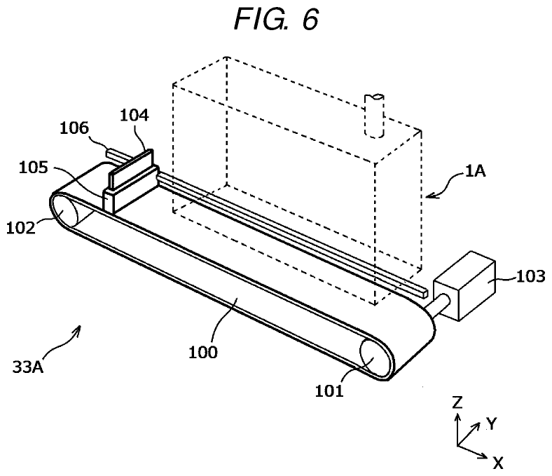

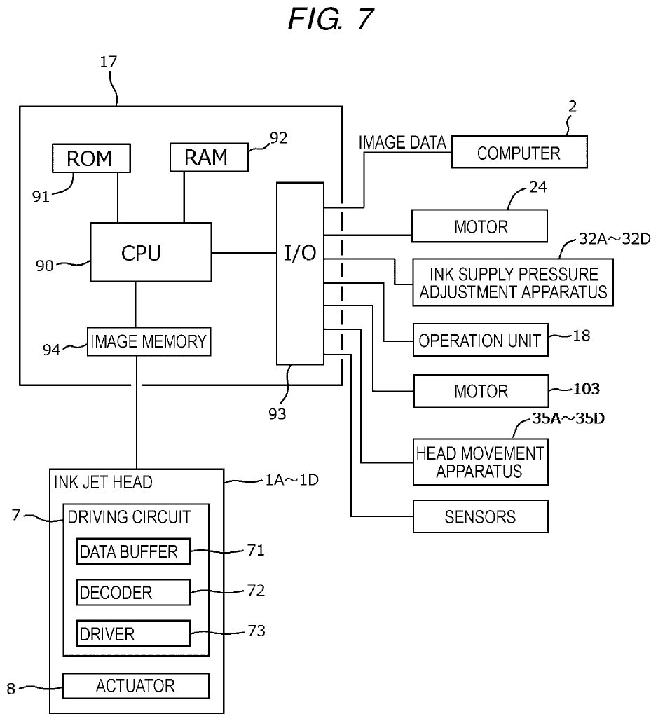

Each of the inkjet heads 1A to 1D includes a maintenance unit. The maintenance units respectively include cleaning apparatuses 33A to 33D that clean the ink jet heads 1A to 1D, and caps 34A to 34D that protect nozzle surfaces of the ink jet heads 1A to 1D. The cleaning apparatuses 33A to 33D remove attached substances attached to the nozzle surfaces of the ink jet heads 1A to 1D. The attached substances are, for example, ink. In addition, for example, dust, sheet dust, and the like may be attached. The ink jet heads 1A to 1D are configured to be movable to cleaning execution positions above the cleaning apparatuses 33A to 33D by head movement apparatuses 35A to 35D (not shown in FIG. 1, and see FIG. 7). Meanwhile, detailed configurations of the cleaning apparatuses 33A to 33D will be described later.

After an image is formed, the sheet S is transmitted from the transport belt 14 to the downstream transport path 15. The downstream transport path 15 is constituted by feed roller pairs 15a, 15b, 15c, and 15d and sheet guide plates 15e and 15f for specifying a transport path of the sheet S. The sheet S is transmitted from an outlet 27 to an ejection tray 16 through the downstream transport path 15. In the drawing, an arrow A4 indicates a transport path of the sheet S.

Subsequently, a configuration of an ink jet head 1A will be described with reference to FIGS. 2 to 7. Meanwhile, ink jet heads 1B to 1D have the same structure as the structure of the ink jet head 1A, and thus detailed description thereof will be omitted.

FIG. 2 is an appearance perspective view of the ink jet head 1A. The ink jet head 1A includes an ink supply unit 4 as a liquid supply unit, a substrate 40, a nozzle plate 5, a flexible substrate 6, and a driving circuit 7. The plurality of nozzles 51 discharging ink is arranged in the nozzle plate 5. Ink discharged from the nozzles 51 is supplied from the ink supply unit 4 communicating with the nozzles 51. The ink flow channel 31A from the ink supply pressure adjustment apparatus 32A is connected to an upper portion side of the ink supply unit 4. An arrow A2 indicates a rotation direction of the existing transport belt 14 (see FIG. 1).

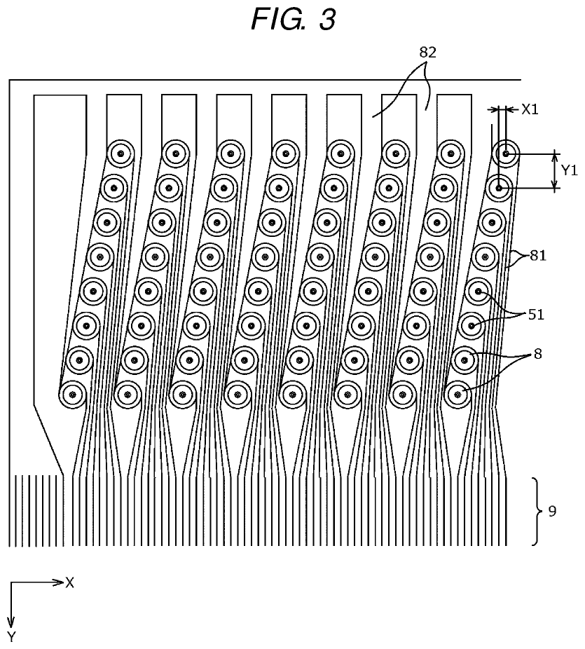

FIG. 3 is a partially enlarged plan view of the nozzle plate 5. The nozzles 51 are arranged two-dimensionally in a column direction (X-axis direction) and a row direction (Y-axis direction) . Here, the nozzles 51 lined up in the row direction (Y-axis direction) are obliquely arranged so that the nozzles 51 do not overlap each other on the axis line of the Y-axis. The nozzles 51 are disposed at intervals of distances X1 in the X-axis direction and intervals of distances Y1 in the Y-axis direction. As an example, the distance X1 is set to 42.3 μm, and the distance Y1 is set to 254 μm. The plurality of nozzles 51 are arranged in the X-axis direction such that eight nozzles 51 arranged in the Y-axis direction are configured as one set. Although not shown in the drawing, for example, a total of 1200 nozzles 51 are arranged in such a manner that 75 sets are arranged in the X-axis direction and two groups are arranged in the Y-axis direction, wherein one group includes 75 sets of nozzles.

An actuator 8 serving as a driving source of an operation of discharging ink is provided for each nozzle 51. The actuators 8 are formed to have an annular shape and are arranged such that the nozzles 51 are positioned at the center thereof . For example, the actuator 8 has sizes of an inner diameter of 30 μm and an outer diameter of 140 μm. The actuators 8 are electrically connected to individual electrodes 81, respectively. Further, regarding the actuators 8, eight actuators 8 lined up in the Y-axis direction are electrically connected to each other through common electrodes 82. The individual electrodes 81 and the common electrodes 82 are further electrically connected to a mounting head 9. The mounting head 9 serves as an input port for supplying a driving signal (electrical signal) to the actuators 8. The individual electrodes 81 respectively supply driving signals to the actuators 8, and the actuators 8 are driven in response to the driving signals. Meanwhile, for convenience of description, the actuators 8, the individual electrodes 81, the common electrodes 82, and the mounting head 9 are shown as solid lines in FIG. 3, but these are disposed inside the nozzle plate 5 (see a longitudinal sectional view of FIG. 5). Naturally, the actuators 8 are not necessarily positioned inside the nozzle plate 5.

The mounting head 9 is electrically connected to a wiring pattern formed in the flexible substrate 6 through, for example, an anisotropic contact film (ACF). Further, the wiring pattern of the flexible substrate 6 is electrically connected to the driving circuit 7. The driving circuit 7 is, for example, an integrated circuit (IC). The driving circuit 7 generates a driving signal to be applied to the actuator 8.

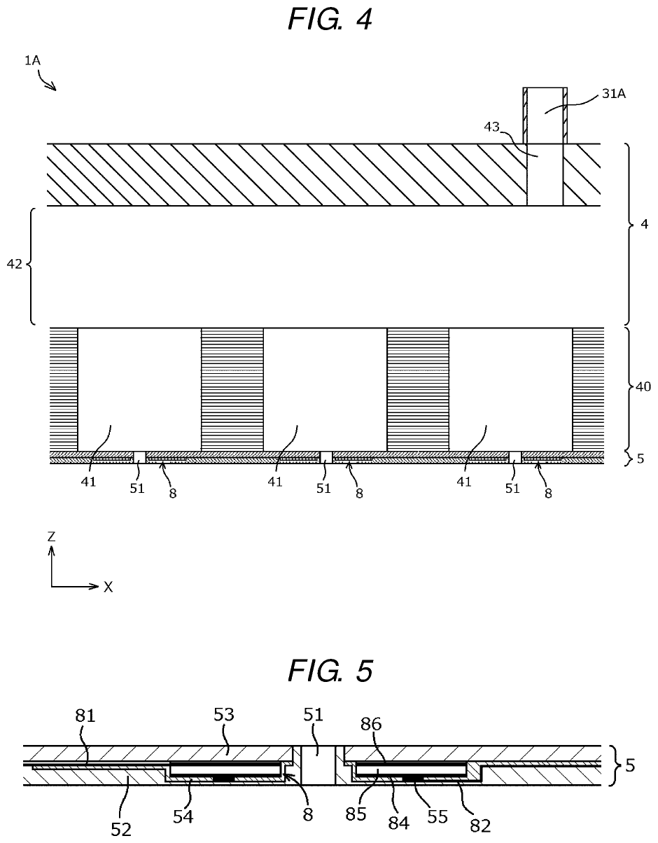

FIG. 4 is a longitudinal sectional view of the ink jet head 1A. As shown in FIG. 4, the nozzles 51 penetrate the nozzle plate 5 in a Z-axis direction. For example, the nozzle 51 has sizes of a diameter of 20 μm and a length of 8 μm. A plurality of pressure chambers (individual pressure chambers) 41 are provided for each nozzle 51 inside the substrate 40. The pressure chambers 41 communicate with the respective nozzles 51. For example, the pressure chamber 41 is a columnar space with an open upper portion. The pressure chamber 41 has an open upper portion to communicate with a common ink chamber 42 in the ink supply unit 4. The ink flow channel 31A communicates with the common ink chamber 42 through an ink supply port 43. The pressure chamber 41 and the common ink chamber 42 are filled with ink. For example, the common ink chamber 42 may be formed to have a flow channel shape for circulating ink. The pressure chamber 41 is configured such that a columnar hole having a diameter of, for example, 200 μm is formed in a substrate 40 constituted by a single crystal silicon wafer having a thickness of, for example, 500 μm. The ink supply unit 4 is configured such that a space corresponding to the common ink chamber 42 is formed in, for example, alumina (Al₂O₃).

FIG. 5 is a partially enlarged view of the nozzle plate 5. The nozzle plate 5 has a structure in which a protection layer 52, the actuator 8, and a vibration plate 53 are stacked in this order from the bottom side. The actuator 8 has a structure in which an upper electrode 84, a piezoelectric body 85 having a thin plate shape, and a lower electrode 86 are stacked. The piezoelectric body 85 having a thin plate shape is an example of a piezoelectric element that drives the actuator 8. The lower electrode 86 is electrically connected to the individual electrode 81, and the upper electrode 84 is electrically connected to the common electrode 82. An insulating layer 54 for preventing the individual electrode 81 and the common electrode 82 from being short-circuited is interposed between the protection layer 52 and the vibration plate 53. The insulating layer 54 is formed of a silicon dioxide film (SiO₂) having a thickness of, for example, 0.5 μm. The upper electrode 84 and the common electrode 82 are electrically connected to each other through a contact hole 55 formed in the insulating layer 54. The piezoelectric body 85 is formed of lead zirconate titanate (PZT) having a thickness of, for example, equal to or less than 5 μm in consideration of piezoelectric characteristics and a dielectric breakdown voltage. The lower electrode 86 and the upper electrode 84 are formed of platinum having a thickness of, for example, 0.15 μm. The individual electrode 81 and the common electrode 82 are formed of gold (Au) having a thickness of, for example, 0.3 μm.

The vibration plate 53 is formed of an insulating inorganic material. The insulating inorganic material is, for example, silicon dioxide (SiO₂). The thickness of the vibration plate 53 is, for example, 2 to 10 μm, and preferably 4 to 6 μm. Although details will be described later, the vibration plate 53 and the protection layer 52 are bent inwards in association with deformation in a d₃₁ mode of the piezoelectric body 85 having a voltage applied thereto. In addition, the piezoelectric body 85 is returned to its original state when the application of a voltage thereto is stopped. The capacity of the pressure chamber (individual pressure chamber) 41 expands and contracts due to the reversible deformation of the piezoelectric body. When the capacity of the pressure chamber 41 is changed, ink pressure in the pressure chamber 41 changes.

The protection layer 52 is formed of polyimide having a thickness of, for example, 4 μm. The protection layer 52 covers one surface of the nozzle plate 5 on the bottom side and covers an inner circumferential surface of the hole of the nozzle 51.

FIG. 6 is a perspective view of the cleaning apparatus 33A. In the drawing, a dotted line indicates the external shape of the ink jet head 1A located at a position for performing cleaning. That is, the ink jet head 1A is positioned, for example, right above the cleaning apparatus 33A. The cleaning apparatus 33A includes an endless rotary belt 100 disposed in the longitudinal direction (X-axis direction) of the ink jet head 1A. A driving pulley 101 and a driven pulley 102 rotatably support the rotary belt 100. A motor 103 rotates the rotary belt 100 by rotating the driving pulley 101. The motor 103 is an example of a driving apparatus.

A wiper blade 104 is attached to a support base 105 provided on the rotary belt 100. The wiper blade 104 and the support base 105 are rotated integrally with the rotary belt 100. In the wiper blade 104, the upper portion thereof is disposed at a height in contact with the bottom surface of the ink jet head 1A, that is, the surface of the nozzle plate 5. The wiper blade 104 is an example of a cleaning member that cleans the nozzle surface of the nozzle plate 5. The wiper blade 104 is disposed such that a side in the longitudinal direction (Y-axis direction) intersects the longitudinal direction (X-axis direction) of the ink jet head 1A. Further, in the wiper blade 104, for example, the length of a side in the longitudinal direction (Y-axis direction) is equal to or greater than the width of the ink jet head 1A in a shorter direction (Y-axis direction). The thickness in the X-axis direction and the height in the Z-axis direction can be appropriately determined in accordance with the size of the ink jet head 1A, and the like.

The wiper blade 104 is formed of, for example, an elastic member having flexibility. The elastic member is, for example, rubber, fluororesin, or the like. A material having liquid repellency to ink and a material having a lyophilic property on the contrary may be selected.

The support base 105 is formed of a resin material such as plastic. For example, the wiper blade 104 is configured to be detachable by being fitted to an upper opening of the support base 105. The wiper blade 104 is replaced when deterioration due to continuous use proceeds. A guide rail 106 is disposed above rotary belt 100 in the longitudinal direction (X-axis direction) of the ink jet head 1A. For example, the guide rail 106 engages with a concave portion formed in the side surface of the support base 105. When cleaning is performed, the motor 103 reciprocates the wiper blade 104 and the support base 105 in the X-axis direction and the −X-axis direction, for example, by rotating the driving pulley 101 forward and reversely. The guide rail 106 guides the support base 105 so that the upper portion of the wiper blade 104 moves while maintaining a fixed height. The wiper blade 104 may be circled in one direction instead of reciprocation. In addition, a container that collects ink and the like removed by the wiper blade 104 may be provided.

When cleaning is performed, the ink jet head 1A is moved to a cleaning execution position shown in FIG. 6 by the head movement apparatus 35A from the ink discharge position shown in FIG. 1. The wiper blade 104 waits at a position (for example, a position shown in FIG. 6) that does not collide with the ink jet head 1A which is moving. The wiper blade 104 cleans the nozzle surface of the nozzle plate 5 by the ink jet head 1A moving to the cleaning execution position and then moving in the X-axis direction.

FIG. 7 is a block diagram of the control system of the ink jet printer 10. The control unit 17 includes a CPU 90, a ROM 91, a RAM 92, an I/O port 93 which is an input and output port, and an image memory 94 which are mounted thereon. The CPU 90 controls the motor 24, the ink supply pressure adjustment apparatuses 32A to 32D, the operation unit 18, the motor 103, the head movement apparatuses 35A to 35D, and various sensors through the I/O port 93. In addition, the CPU 90 reads out and executes, for example, various programs stored in the ROM 91. The various programs include a program for executing cleaning. Image data from the computer 2 which is external connection equipment is transmitted to the control unit 17 through the I/O port 93 and is stored in the image memory 94. The CPU 90 transmits the image data stored in the image memory 94 to the driving circuit 7 in order of drawing.

The driving circuit 7 includes a data buffer 71, a decoder 72, and a driver 73. The data buffer 71 stores image data for each actuator 8 in time series. The decoder 72 controls the driver 73 on the basis of the image data stored in the data buffer 71 for each actuator 8. The driver 73 outputs a driving signal for operating the actuators 8 under the control of the decoder 72. The driving signal is a voltage to be applied to the actuators 8.

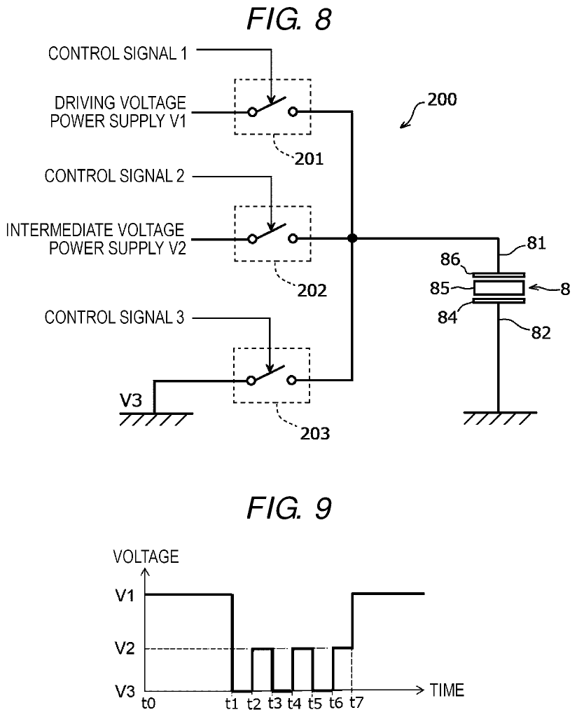

FIG. 8 is a circuit diagram of a driving signal supply circuit 200 that supplies a driving signal to the actuator 8. The driving signal supply circuit 200 in the present embodiment also serves as a low impedance circuit that connects the piezoelectric body 85 of the actuator 8 to a ground or a power supply during cleaning of the ink jet head 1A, as will be describe later in detail. The driving signal supply circuit 200 is formed for each actuator 8 inside the driving circuit 7. Naturally, the driving signal supply circuit 200 may be provided separately from the driving circuit 7. As shown in FIG. 8, the lower electrode 86 of the actuator 8 is connected to the driving signal supply circuit 200 through the individual electrode 81. On the other hand, the upper electrode 84 of the actuator 8 is grounded through the common electrode 82.

In the driving signal supply circuit 200, three switches 201, 202, and 203 are disposed in parallel. The switches 201, 202, and 203 are driving circuit elements. The first switch 201 is electrically connected to a driving voltage power supply. The second switch 202 is electrically connected to an intermediate voltage power supply. The third switch 203 is grounded. The driving signal supply circuit 200 supplies control signals 1 to 3 to the switches 201, 202, and 203 to control switching between turn-on and turn-off of the switches 201, 202, and 203. The switches 201, 202, and 203 are, for example, transistors. The transistors are, for example, electric field effect transistors (MOS-FET).

Meanwhile, the above-described driving voltage is a voltage V1 in a driving waveform of FIG. 9, an intermediate voltage is a voltage V2, and a ground voltage is a voltage V3 (=0 V). When the first switch 201 is turned on, an output signal from the switch 201 corresponding to the voltage V1 is supplied to the actuator 8. When the second switch 202 is turned on, an output signal from the switch 202 corresponding to the voltage V2 is supplied to the actuator 8. When the third switch 203 is turned on, an output signal from the switch 203 corresponding to the voltage V3 (=0 V) is supplied to the actuator 8. The supply of these output signals is performed on the actuator 8 of the nozzle 51 that discharges ink.

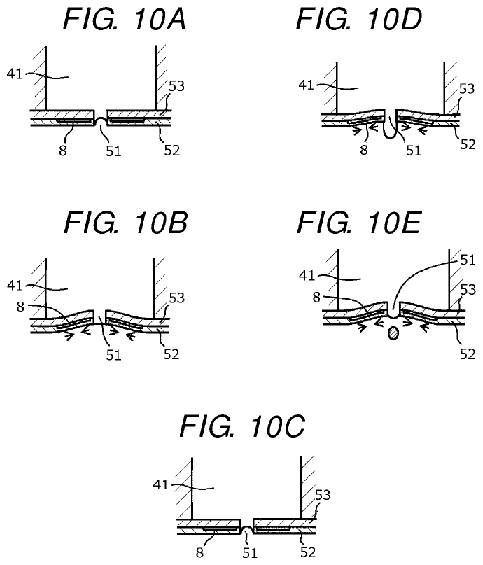

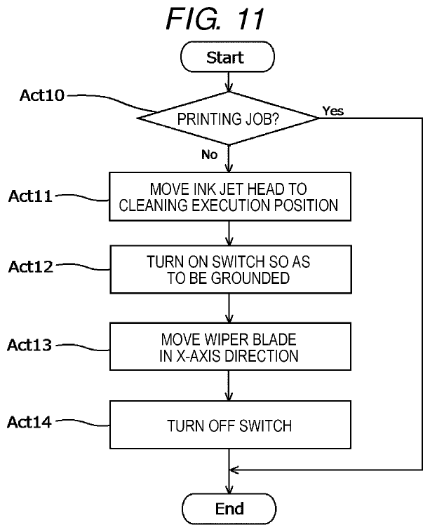

Subsequently, a relationship between a waveform (driving waveform) of a driving signal to be supplied to the actuator 8 and an operation of discharging ink from the nozzle 51 will be described with reference to FIGS. 9 and 10. Thereafter, a cleaning operation of the ink jet head 1A using the cleaning apparatus 33A will be described with reference to FIGS. 11 to 15.

FIG. 9 shows a driving waveform of multi-drop in which ink droplets are dropped three times at one driving cycle using a triple pulse, as an example of a driving waveform. When ink is dropped at high speed, the ink becomes one droplet and lands on the sheet S. The driving waveform of FIG. 9 is a so-called pulling driving waveform. However, the driving waveform is not limited to the triple pulse. For example, a single pulse or a double pulse may be used. In addition, the driving waveform is not limited to pulling, and pushing or pushing and pulling may be used.

The driving circuit 7 turns on the first switch 201 of the driving signal supply circuit 200 from time t0 to time t1 to apply a bias voltage V1 to the actuator 8. That is, the voltage V1 is applied between the lower electrode 86 and the upper electrode 84. In addition, after the third switch 203 of the driving signal supply circuit 200 is turned on from time t1 at which an ink discharge operation is started to time t2 to apply a voltage V3 (=0 V), the second switch 202 of the driving signal supply circuit 200 is turned on from time t2 to time t3 and a voltage V2 is applied to perform first ink dropping. Further, after the third switch 203 of the driving signal supply circuit 200 is turned on from time t3 to time t4 to apply a voltage V3 (=0 V), the second switch 202 of the driving signal supply circuit 200 is turned on from time t4 to time t5 and a voltage V2 is applied to perform second ink dropping. Further, after the third switch 203 of the driving signal supply circuit 200 is turned on from time t5 to time t6 and a voltage V3 (=0 V) is applied, the second switch 202 of the driving signal supply circuit 200 is turned on from time t6 to time t7 and a voltage V2 is applied to perform third ink dropping. The first switch 201 of the driving signal supply circuit 200 is turned on at time t7 after the termination of dropping and a bias voltage V1 is applied to attenuate residual vibration inside the pressure chamber 41.

The voltage V2 is a voltage lower than the bias voltage V1, and a voltage value is determined on the basis of, for example, an attenuation rate of pressure vibration of ink inside the pressure chamber 41. A period of time between time t1 and time t2, a period of time between time t2 and time t3, a period of time between time t3 and time t4, a period of time between time t4 and time t5, a period of time between time t5 and time t6, and a period of time between time t6 and time t7 are set to a half cycle of a specific vibration cycle λ determined depending on characteristics of ink and an internal structure of the head. The half cycle of the specific vibration cycle λ is also called an acoustic length (AL) . Meanwhile, the voltage of the grounded common electrode 82 is fixed to 0 V during a series of operations.

FIGS. 10A to 10E schematically show an operation in which the actuator 8 is driven in accordance with the driving waveform of FIG. 9 and ink is discharged. A standby state is set from time t0 to time t1. When a bias voltage V1 is applied in the standby state, an electric field is generated in the thickness direction of the piezoelectric body 85, and deformation in a d31 mode occurs in the piezoelectric body 85 as shown in FIG. 10B. Specifically, the piezoelectric body 85 having an annular shape expands in the thickness direction and contracts in a radial direction. Bending stress is generated in the vibration plate 53 due to the deformation of the piezoelectric body 85, and thus the actuator 8 is bent inwards. That is, the actuator 8 is deformed so as to be recessed centering on the nozzle 51, and the capacity of the pressure chamber 41 is reduced.

When a voltage V3 (=0 V) as an expansion pulse is applied at time t1, the actuator 8 returns to a state before deformation as schematically shown in FIG. 10C. In this case, an internal ink pressure is decreased inside the pressure chamber 41 due to the capacity being returned to its original state, but the ink pressure is increased due to the supply of ink to the pressure chamber from the common ink chamber 42. Thereafter, the supply of ink to the pressure chamber 41 is stopped at time t2, and an increase in the ink pressure is also stopped. That is, a so-called pulling state is set.

When a voltage V2 as a contraction pulse is applied at time t2, the piezoelectric body 85 of the actuator 8 is deformed again, and thus the capacity of the pressure chamber 41 is reduced. As described above, ink pressure increases between time t1 and time t2, and ink pressure is increased by pressing the pressure chamber 41 using the actuator 8 so as to reduce the capacity of the pressure chamber 41, and thus ink is pushed out from the nozzle 51 as schematically shown in FIG. 10D. The application of the voltage V2 is continued until time t3, and ink becomes a droplet as schematically shown in FIG. 10E and is discharged from the nozzle 51. That is, first ink dropping is performed.

After a voltage V3 (=0 V) is applied from time t3 to time t4, second ink dropping is performed using the same operations and actions as when a voltage V2 is applied from time t4 to time t5 (FIGS. 10B to 10E) . Further, after a voltage V3 (=0 V) is applied from time t5 to time t6, third ink dropping is performed using the same operations and actions as when a voltage V2 is applied from time t6 to time t7 (FIGS. 10B to 10E).

When the third ink dropping is performed, a voltage V1 as a cancellation pulse is applied at time t7. Ink pressure inside the pressure chamber 41 is decreased by discharging ink. Further, vibration of the ink remains inside the pressure chamber 41. Consequently, the actuator 8 is driven so that the capacity of the pressure chamber 41 is reduced by lowering a voltage from the voltage V2 to the voltage V1, and ink pressure inside the pressure chamber 41 is substantially set to 0 so as to forcibly attenuate residual vibration of ink inside the pressure chamber 41.

As an example, the cleaning of the ink jet head 1A is performed according to a procedure shown in FIG. 11. That is, the control unit 17 determines whether a printing job is not executed and any printing job is not also received in a state where a main power supply of the ink jet printer 10 is turned on (Act10) . As an example, this determination may be performed when the number of printed sheets S reach a predetermined number, may be performed when an idle state is continued for a predetermined period of time, may be performed at the time of initial start-up when an idle state is continued for a predetermined period of time, may be performed at the time of initial start-up when the main power supply of the ink jet printer 10 is turned on, or may be performed as a termination process when a switch of the main power supply is turned off .

When it is determined that a printing job is not executed and any printing job is not also received (Act10, no), the control unit 17 moves the ink jet head 1A in the Z-axis direction and the Y-axis direction by the head movement apparatus 35A and positions the ink jet head 1A at the cleaning execution position shown in FIG. 6 (Act11) . On the other hand, when a printing job is being executed or a printing job is received (Act10, yes), the control unit 17 terminates the cleaning process without executing cleaning.

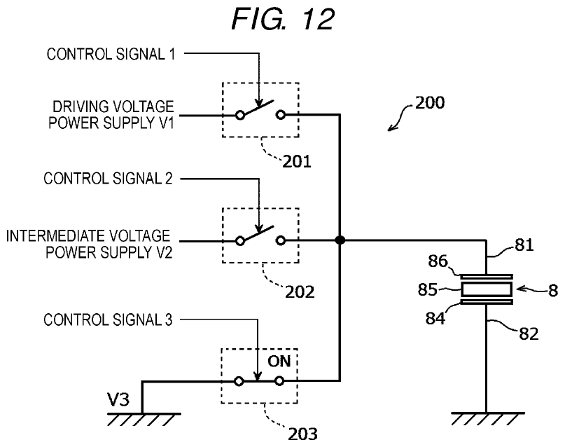

Subsequently, the control unit 17 controls the driving signal supply circuit 200 so as to turn on the third switch 203 as shown in FIG. 12 (Act12) . When a printing job or cleaning is not executed, all of the switches 201, 202, and 203 are turned off so as to reduce power consumption of the printing apparatus, and thus the third switch 203 is operated so as to be turned on. The first switch 201 and the second switch 202 are kept turned off.

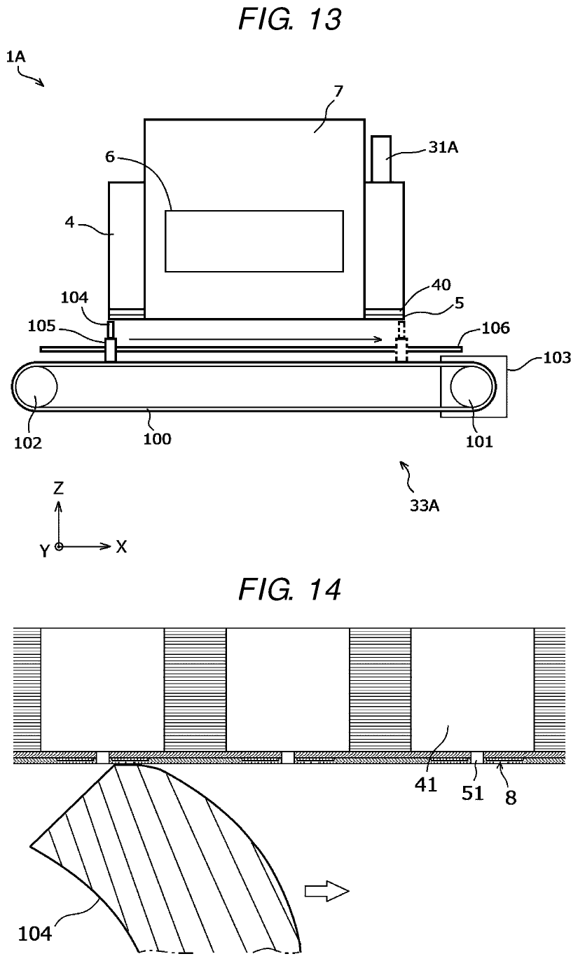

Subsequently, the control unit 17 rotates the rotary belt 100 to move the wiper blade 104 in the X-axis direction as shown in FIG. 13. When the wiper blade 104 is moved in the X-axis direction, the upper portion of the wiper blade 104 having flexibility moves while cleaning the nozzle surface of the nozzle plate 5 as schematically shown in FIG. 14. Further, the nozzle surface may also be cleaned through reciprocation by moving the wiper blade in the −X-axis direction. When attached substances such as ink are attached to the surface of the nozzle plate 5, the attached substances are removed through cleaning of the wiper blade 104.

When cleaning is performed while moving the wiper blade 104 in the X-axis direction, the nozzle plate 5 may be deformed as if, for example, a wave moves forward due to stress such as a pressing force or a frictional force from the wiper blade 104. Further, in a region in which the actuators 8 are disposed, the piezoelectric bodies 85 of the actuators 8 may be deformed together with the nozzle plate 5, and charge may be generated due to the action of a piezoelectric effect. In this case, when all of the switches 201, 202, and 203 are kept turned off for a reason to reduce power consumption, there is a concern that circuits on sides of output ends of the switches 201, 202, and 203 may be set to be in a high impedance state and may exert adverse influences on the driving circuit 7. In some cases, there is a concern that the switches 201, 202, and 203 which are driving circuit elements maybe broken. On the other hand, when the third switch 203 is turned on, a low impedance state is set, and thus charge generated by the piezoelectric body 85 escapes to a ground line.

When the cleaning performed by the wiper blade 104 is completed, the control unit 17 returns the wiper blade 104 to a standby position and then stops the motor 103. Further, the third switch 203 is turned off to terminate the cleaning (Act14). That is, all of the switches 201, 202, and 203 are turned off again to reduce power consumption of the printing apparatus. The ink jet head 1A having terminated cleaning is returned to the ink discharge position shown in FIG. 1. Alternatively, the nozzle surface is protected using the cap 34A.

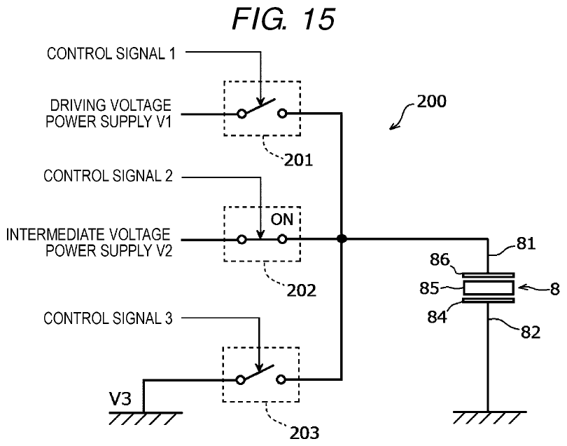

Meanwhile, in the above-described embodiment, cleaning is performed in a state where the third switch 203 is turned on, but cleaning may be performed in a state where the second switch 202 is turned on and connected to the intermediate voltage power supply as shown in FIG. 15. Since a low impedance state can be set if an impedance is several ohms (Ω) even when the second switch is connected to the intermediate voltage power supply, charge generated by the piezoelectric body 85 can be released to a power supply. As a modification example in which charge is released to a power supply, cleaning may be performed in a state where the first switch 201 is turned on instead of the second switch 202 and is connected to the driving voltage power supply.

According to the above-described embodiment, cleaning is performed in a state where any one of the switches 201, 202, and 203 of the driving signal supply circuit 200 is turned on and the piezoelectric body 85 of the actuator 8 is connected to a ground or a power supply through the driving signal supply circuit 200. In this manner, a circuit on a side of an output end of the driving signal supply circuit 200 is set to be in a low impedance state, and thus charge can be released to a ground line or a power supply even when the piezoelectric body 85 unexpectedly generates the charge during cleaning. As a result, it is possible to prevent the circuit from being set to be in a high impedance state and exerting adverse influences . In addition, it is possible to prevent driving circuit elements such as the switches 201, 202, and 203 from being broken.

In this manner, in a configuration in which any one of the switches 201, 202, and 203 of the driving signal supply circuit 200 is turned on to set a low impedance state, the driving signal supply circuit 200 functions as a low impedance circuit that connects the piezoelectric body 85 of the actuator 8 to a ground or a power supply during cleaning. Therefore, design change for newly providing a low impedance circuit may not be performed, and there is an advantage in that the number of components is not increased. In addition, when the third switch 203 is turned on, the nozzle plate 5 is in a flat state as schematically shown in FIG. 10C, and thus the wiper blade 104 easily cleans the nozzle surface.

### Second Embodiment

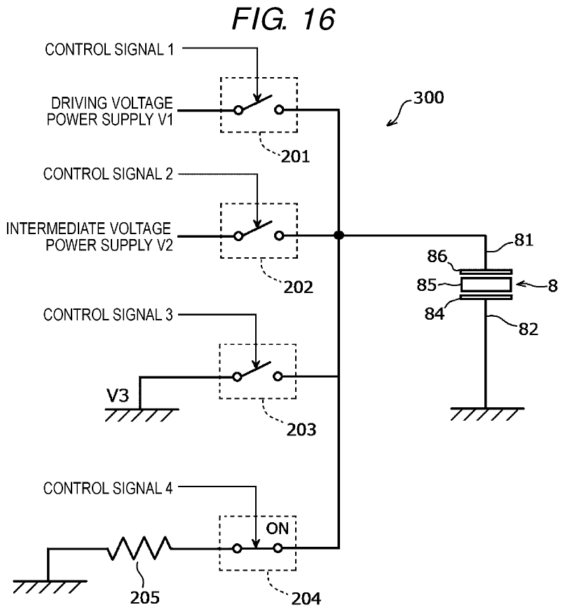

Subsequently, a liquid discharge apparatus 1 according to a second embodiment will be described by taking an ink jet head 1A as an example. FIG. 16 is a circuit diagram of a driving signal supply circuit 300 included in the ink jet head 1A described in the second embodiment. That is, the ink jet head 1A described in the second embodiment has the same configuration as that of the ink jet head 1A described in the first embodiment except that a configuration of the driving signal supply circuit 300 is different from that of the driving signal supply circuit 200. Therefore, the same components will be denoted by the same reference numerals and signs, and thus detailed description will be omitted.

The driving signal supply circuit 300 includes a fourth switch 204. The fourth switch 204 is connected to a resistance element 205, and the resistance element 205 is grounded. In addition, a control unit 17 supplies a control signal 4 to turn on the fourth switch 204 during cleaning. In addition, cleaning is performed in a state where a piezoelectric body 85 of an actuator 8 is connected to the resistance element 205. That is, in the present embodiment, a circuit to which the fourth switch 204 and the resistance element 205 are connected constitutes a low impedance circuit. An element other than the resistance element 205 may be used. Even with such a configuration, a circuit on a side of an output end of the driving signal supply circuit 300 is set to be in a low impedance state, and thus charge can be released to a low impedance circuit even when the piezoelectric body 85 unexpectedly generates the charge during cleaning.

### Third Embodiment

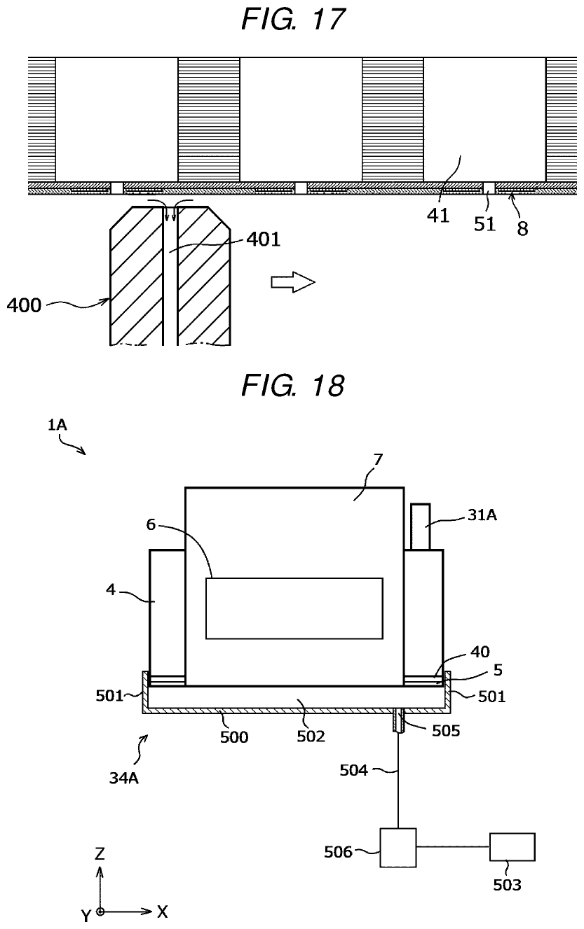

Subsequently, a liquid discharge apparatus 1 according to a third embodiment will be described by taking an ink jet head 1A as an example. FIG. 17 schematically shows a state where cleaning is performed by suctioning a nozzle surface of a nozzle plate 5 using a suction member 400 as a cleaning member. That is, the ink jet head 1A described in the third embodiment has the same configuration as that of the ink jet head 1A described in the first embodiment or the second embodiment except that the nozzle plate 5 is cleaned using a suction-type cleaning apparatus instead of performing cleaning using the wiper blade 104. Therefore, the same components will be denoted by the same reference numerals and signs, and thus detailed description will be omitted.

The suction member 400 is disposed on a rotary belt 100 and is movable in the X-axis direction, similar to the wiper blade 104. In the suction member 400, a suction port 401 is decompressed by a decompression apparatus not shown in the drawing while the suction member is moving in the X-axis direction. Attached substances attached to the surface of the nozzle plate 5 are suctioned from the suction port 401. Cleaning performed by the suction member 400 is performed in a state where any one of first to fourth switches 201 to 204 is turned on, similar to the first embodiment or the second embodiment. Even when the nozzle plate 5 is deformed due to a suction force and charge is generated in a piezoelectric body 85 of an actuator 8, the charge can be released to any one of a ground line, a driving voltage power supply, an intermediate voltage power supply, and a resistance element 205, similar to the first embodiment or the second embodiment. Meanwhile, suction-type cleaning can also be used to eliminate clogging inside the nozzle 51.

### Fourth Embodiment

Subsequently, a liquid discharge apparatus 1 according to a fourth embodiment will be described by taking an ink jet head 1A as an example. FIG. 18 schematically shows a state where cleaning is performed by suctioning the entire nozzle surface of a nozzle plate 5 using a sealed cleaning apparatus. That is, the ink jet head 1A described in the fourth embodiment has the same configuration as those of the ink jet heads 1A described in the first to third embodiments except that cleaning is performed, for example, by suctioning the nozzle surface of the nozzle plate 5 at once, instead of performing cleaning while moving a wiper blade 104 or a suction member 400. Therefore, the same components will be denoted by the same reference numerals and signs, and thus detailed description will be omitted.

A cleaning apparatus according to the fourth embodiment has a configuration in which a suction function is added to a cap 34A protecting the nozzle surface, as an example. That is, the cap 34A functions as a cleaning member. The cap 34A has a concave shape by a bottom surface 500 facing the nozzle surface of the nozzle plate 5 and an erected wall 501 formed along the outer circumference of the bottom surface 500. In the drawing, the cap 34A is shown in a longitudinal sectional view. The cap 34A is mounted from below the ink jet head 1A to form a sealed space 502 surrounding the nozzle surface of the nozzle plate 5. A decompression apparatus 503 that decompresses the inside of the sealed space 502 in order to perform suction is connected to an exhaust hole 505 formed in the bottom surface of the cap 34A through an exhaust passage 504. The decompression apparatus 503 is, for example, a decompression pump. A container 506 collecting ink is provided in the middle of the exhaust passage 504. Besides, a valve, a pressure sensor, and the like may be provided.

Cleaning is performed by mounting the cap 34A on the ink jet head 1A and then operating the decompression apparatus 503 for a predetermined period of time. As an example, cleaning is performed when a printing job is not performed for a long period of time, when clogging occurs in a nozzle 51, and the like. It is possible to clean the nozzle surface of the nozzle plate 5 by suctioning the sealed space 502 surrounding the nozzle surface to particularly discharge ink in the vicinity of the nozzle 51 or an object which is the cause of clogging. Similarly to the first to third embodiments, cleaning is performed in a state where any one of first to fourth switches 201 to 204 is turned on. Even when the nozzle plate 5 is deformed due to a suction force and charge is generated in a piezoelectric body 85 of an actuator 8, the charge can be released to any one of a ground line, a driving voltage power supply, an intermediate voltage power supply, and a resistance element 205, similar to the first to third embodiments.

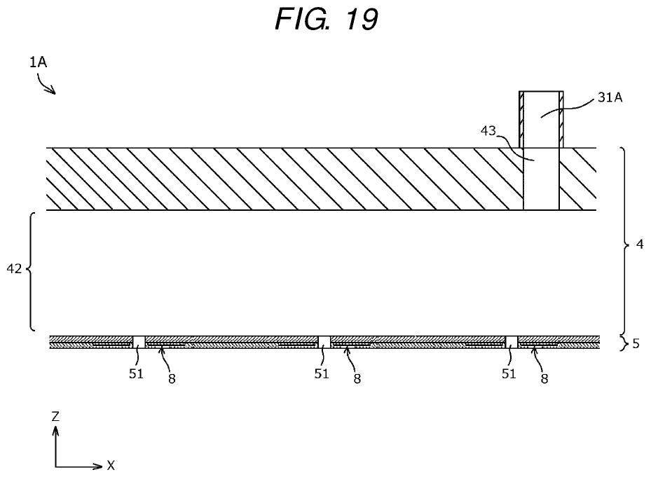

Although the ink jet heads 1A according to the first to fourth embodiments have been described in detail, the pressure chambers (individual pressure chambers) 41 may be omitted and the nozzle plate 5 may directly communicate with the common ink chamber 42 as shown in FIG. 19, as a modification example of the ink jet head 1A.

In the first to fourth embodiments, the protection of the driving circuit 7 when charge is generated due to deformation of the actuator 8 during cleaning of the ink jet head 1A has been described. However, for example, when there is a concern that the nozzle plate 5 may be deformed due to stress caused by external factors such as a case where the cap 34A protecting the nozzle surface is attached to the ink jet head 1A, it is possible to protect the driving circuit 7 even when the actuator 8 unexpectedly generates charge in a state where any one of the first to fourth switches 201 to 204 is turned on.

Cleaning may also be manually performed without being automatically performed as in the first to fourth embodiments.

Further, in the ink jet head 1A, both the actuator 8 and the nozzle 51 may not be disposed on the surface of the nozzle plate 5. For example, an ink jet head including an actuator of any one driving type among a drop on demand piezo type, a share wall type, and a share mode type may be used.

Further, in the above-described embodiments, the ink jet head 1A of the ink jet printer 1 has been described as an example of a liquid discharge apparatus, but the liquid discharge apparatus may be a molding material discharge head of a 3D printer or a sample discharge head of a dispensing apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid discharge apparatus, comprising:
a nozzle plate comprising a plurality of nozzles for discharging a liquid are arranged;
a liquid supply unit which communicates with the nozzles;
a plurality of actuators each of which is provided for a respective nozzle of the plurality of nozzles in the nozzle plate, each actuator comprising a piezoelectric element;
a driving circuit which supplies a driving signal to the piezoelectric elements of the actuators and drives the actuators to discharge the liquid from the nozzles; and
a low impedance circuit which is connected to the piezoelectric elements of the actuators while stress is applied to the nozzle plate due to external factors.

2. The apparatus according to claim 1, further comprising:
a cleaning member which cleans or suctions a nozzle surface of the nozzle plate, wherein
the low impedance circuit is connected to the piezoelectric elements of the actuators while the cleaning member cleans or suctions the nozzle surface.

3. The apparatus according to claim 1, wherein
the low impedance circuit connects the piezoelectric elements of the actuators to a ground or a power supply.

4. The apparatus according to claim 1, wherein
the piezoelectric elements of the actuators are configured to be deformed integrally with the nozzle plate.

5. The apparatus according to claim 1, wherein
the actuators are positioned inside the nozzle plate.

6. The apparatus according to claim 1, wherein
the actuators are positioned outside the nozzle plate.

7. The apparatus according to claim 1, wherein
each actuator comprises an upper electrode and lower electrode with a piezoelectric body therebetween.

8. The apparatus according to claim 2, wherein
the cleaning member comprises a wiper blade coupled to an endless belt.

9. The apparatus according to claim 8, wherein
the wiper blade is made of an elastic material.

10. An ink jet printer, comprising:
an ink jet head which includes a nozzle plate comprising a plurality of nozzles for discharging ink are arranged, an ink supply unit communicating with the nozzles, a plurality of actuators, each provided for a respective nozzle of the plurality of nozzles in the nozzle plate and each including a piezoelectric element, and a driving circuit supplying a driving signal to the piezoelectric elements of the actuators and driving the actuators to discharge the ink from the nozzles;
a low impedance circuit which is connected to the piezoelectric elements of the actuators while stress is applied to the nozzle plate due to external factors;
a recording medium transport apparatus which transports a recording medium to a position facing the ink jet head; and
a control unit which controls the ink jet head so as to discharge ink to a predetermined position on the recording medium.

11. The ink jet printer according to claim 10, further comprising:
a cleaning member which cleans or suctions a nozzle surface of the nozzle plate, wherein
the low impedance circuit is connected to the piezoelectric elements of the actuators while the cleaning member cleans or suctions the nozzle surface.

12. The ink jet printer according to claim 10, wherein
the low impedance circuit connects the piezoelectric elements of the actuators to a ground or a power supply.

13. The ink jet printer according to claim 10, wherein
the piezoelectric elements of the actuators are configured to be deformed integrally with the nozzle plate.

14. The ink jet printer according to claim 10, wherein
the actuators are positioned inside the nozzle plate.

15. The ink jet printer according to claim 10, wherein
the actuators are positioned outside the nozzle plate.

16. The ink jet printer according to claim 10, wherein
each actuator comprises an upper electrode and lower electrode with a piezoelectric body therebetween.

17. The ink jet printer according to claim 11, wherein
the cleaning member comprises a wiper blade coupled to an endless belt.

18. The ink jet printer according to claim 17, wherein
the wiper blade is made of an elastic material.

19. A method of operating a liquid discharge apparatus comprising a nozzle plate comprising a plurality of nozzles for discharging a liquid are arranged, a liquid supply unit which communicates with the nozzles, a plurality of actuators each of which is provided for a respective nozzle of the plurality of nozzles in the nozzle plate, each actuator comprising a piezoelectric element, the method comprising:
supplying a driving signal to the piezoelectric elements of the actuators and driving the actuators to discharge the liquid from the nozzles; and
connecting a low impedance circuit to the piezoelectric elements of the actuators while stress is applied to the nozzle plate due to external factors.

20. The method according to claim 19, further comprising:
cleaning a nozzle surface of the nozzle plate while connecting the low impedance circuit to the piezoelectric elements of the actuators.
